(19) United States
(12) Patent Application Publication
(10) Pub. No.: US 2010/0131115 A1
(43) Pub. Date: May 27, 2010

(54) CONTROLLING METHOD OF AIR CONDITIONER

(76) Inventors: Bum Suk Kim, Gyeongsangnam-do (KR); Sang Kyoung Park, Gyeongsangnam-do (KR); Young Hwan Ko, Gyeongsangnam-do (KR); Hyuk Soo Lee, Gyeongsangnam-do (KR)

Correspondence Address: MCKENNA LONG & ALDRIDGE LLP, 1900 K STREET, NW, WASHINGTON, DC, 20006, US

(21) Appl. No.: 12/312,457

(22) PCT Filed: Oct. 23, 2007
(86) PCT No.: PCT/KR2007/005194

§ 371 Date: Jan. 22, 2010

(30) Foreign Application Priority Data
Nov. 13, 2006 (KR) 10-2006-0111771

(51) Int. Cl. G05D 7/00

(52) U.S. Cl. 700/282

(57) ABSTRACT

The present invention relates to a controlling method of an air conditioner. The controlling method of an air conditioner having a phase separator, an expansion valve, a control valve, an evaporator, a multistage compressor, and a condenser, includes the steps of sensing an order to operate the air conditioner, stabilizing the air conditioner, setting a degree of superheat of refrigerant in the air conditioner, and setting an optimum intermediate pressure of the refrigerant of the air conditioner.

### TECHNICAL FIELD

The present invention relates to a method for controlling an air conditioner. More specifically, the present invention relates to a method for controlling an air conditioner which can stabilize an air conditioning system while preventing liquid refrigerant from entering into a compressor when the air conditioner is operated.

### BACKGROUND ART

Generally, an air conditioning system cools and/or heats a room space as the refrigerant is compressed, condensed, expanded, and evaporated. In the air conditioning system, there are a general air conditioning system in which one indoor unit is connected to one outdoor unit, and a multi-air conditioning system in which a plurality of indoor units are connected to one outdoor unit. Or, there are a room cooling system in which a refrigerating cycle is operated only in one direction only to supply cold air to the room, and a room cooling/heating system in which the refrigerating cycle is operated in two directions selectively, to supply cold or warm air to the room.

A related art air conditioner will be described with reference to FIG. 1, briefly.

Referring to FIG. 1, basically, the related art air conditioner has a refrigerating cycle having a compressor 1a, and 1b, a condenser 3, an expansion valve 4, an evaporator 5 formed therein. The foregoing units are connected with a connection pipeline 7 which serves as a passage of refrigerant.

The steps of a process of the related art air conditioner for cooling a room space will be described following a refrigerant flow.

Gaseous refrigerant heat exchanged with room air at the evaporator 5 is introduced to, and compressed at, the compressor 1a, and 1b to high temperature, and high pressure. Then, the high temperature/high pressure gaseous refrigerant is introduced to, and involved in a phase change to liquidus refrigerant at, the condenser 3. As the refrigerant is changing a phase thereof at the condenser, the refrigerant 3 emits heat. Then, the refrigerant from the condenser 3 passes through, and is expanded at, the expansion valve 4, and is introduced to the evaporator 5. The liquidus refrigerant introduced to the evaporator 5 absorbs heat from an outside of the evaporator 5 as the liquidus refrigerant is changing a phase thereof, to cool the room space. In the meantime, in order to heat the room space, it is required to run the foregoing refrigerating cycle in a reverse direction.

In the meantime, there is an accumulator 6 between the evaporator 5 and the compressor 1a, and 1b. The accumulator 6 holds a mixture of oil and the refrigerant temporally, to prevent the refrigerant from flowing in a reverse direction and the liquidus refrigerant from entering into the compressor 1a, and 1b.

Referring to FIG. 1, in the compressor 1a and 1b, there are a first compressor 1a and a second compressor 1b each connected to the condenser 3 individually. The first and second compressors 1a and 1b have capacities different from each other and are constant speed compressors each having a constant operation speed. Therefore, the compressors are put into operation according to a load of the air conditioner. At the end, a refrigerant flow to the condenser 3 from the first compressor 1a is controlled by a first check valve 2a, and a refrigerant flow to the condenser 3 from the second compressor 1b is controlled by a second check valve 2b.

### DISCLOSURE OF INVENTION

### Technical Problem

However, the related art air conditioner has a problem in that entrance of the liquidus refrigerant to the compressors 1a and 1b can not be prevented perfectly in a case the air conditioner is put into operation again after the air conditioner is stopped even if an accumulator 6 is provided, to cause a serious problem of compressor damage in a case the liquidus refrigerant enters into the compressors 1a, 1b.

Moreover, since a fixed power is supplied to the compressors even in a case a load required for the air conditioner changes, power is consumed unnecessarily, and operation efficiency becomes poor. Furthermore, the two compressors with independent driving units causes limitation of an installation space, and increases a production cost of air conditioner.

### Technical Solution

To solve the problems, an object of the present invention is to provide a method for controlling an air conditioner which can prevent liquidus refrigerant from entering into a compressor at an initial stage of operation of the air conditioner.

Another object of the present invention is to provide a method for controlling an air conditioner which enables to stabilize operation of the air conditioner at an initial stage of the operation.

To achieve these objects and other advantages and in accordance with the purpose of the invention, as embodied and broadly described herein, a method for controlling an air conditioner having a phase separator, an expansion valve, a control valve, an evaporator, a multistage compressor, and a condenser, wherein the expansion valve includes a first valve for expanding refrigerant being supplied from the condenser to the phase separator, and a second valve for expanding liquidus refrigerant being supplied from the phase separator to the evaporator, and the control valve guides gaseous refrigerant from the phase separator to the multistage compressor, includes the steps of sensing an order to operate the air conditioner, initializing degrees of opening of the first, second valves, and the control valve, controlling a degree of superheat of refrigerant in the air conditioner so that the refrigerant reaches to a predetermined degree of superheat, and controlling an intermediate pressure of the refrigerant of the air conditioner so that the refrigerant reaches to a predetermined optimum intermediate pressure.

The step of initializing degrees of opening includes the step of full opening of the first, and second valves, and closing the control valve.

In the meantime, the step for setting a degree of superheat of refrigerant includes the steps of controlling the degree of opening of the first valve until the degree of superheat of the refrigerant reaches to the predetermined degree of superheat, and setting the degree of opening of the first valve in a case the refrigerant reaches to the predetermined degree of superheat.

The step for controlling the degree of opening of the first valve includes the step of measuring the degree of superheat of the refrigerant while varying the degree of opening of the first valve until the degree of superheat of the refrigerant reaches to the predetermined degree of superheat of the refrigerant.

In the meantime, the degree of superheat is measured with sensors mounted to an outlet of the evaporator and an inlet of the compressor respectively, and the sensors are temperature sensors, or pressure sensors.

The step of controlling the degree of opening of the first valve until the degree of superheat of the refrigerant reaches to the predetermined degree of superheat includes the step of opening the first valve to a predetermined degree of opening with reference to a table predetermined according to temperature differences between inside/outside of a room so that the refrigerant reaches to the predetermined degree of superheat.

The step for setting a degree of superheat of refrigerant further includes the step of stabilizing in which lapse of a predetermined time period is waited in a state the degree of opening of the first valve is set.

The step of setting an optimum intermediate pressure of the refrigerant of the air conditioner includes the step of controlling the degree of opening of the control valve so that the refrigerant reaches to the predetermined optimum intermediate pressure.

The step of setting an optimum intermediate pressure of the refrigerant of the air conditioner includes the step of the intermediate pressure of the refrigerant is measured while varying the degree of opening of the control valve until the refrigerant reaches to the predetermined optimum intermediate pressure.

The intermediate pressure is measured with sensors mounted to opposite ends of a line through which gaseous refrigerant is discharged from the phase separator respectively, or the intermediate pressure is measured with sensors mounted to an inlet and an outlet of the compressor, respectively. the sensors are temperature sensors, or pressure sensors.

In the meantime, the step of setting an optimum intermediate pressure of the refrigerant of the air conditioner includes the step of opening the control valve to a predetermined degree of opening with reference to a data table predetermined according to temperature differences between inside/outside of a room, so that the refrigerant reaches to the optimum intermediate pressure.

The method further includes a re-controlling step for controlling the degree of opening of the second valve until the degree of superheat and the intermediate pressure of the refrigerant reach to predetermined values again in a case the degree of the superheat fails to be the same with the predetermined degree of superheat of the refrigerant by the control of the control valve.

The method further includes the step of repeating the step of setting a degree of superheat of refrigerant in the air conditioner, the step of setting an optimum intermediate pressure of the refrigerant of the air conditioner, and the re-controlling step if an external load disturbance takes place after the re-controlling step.

### BRIEF DESCRIPTION OF THE DRAWINGS

The accompanying drawings, which are included to provide further understanding of the disclosure and are incorporated in and constitute a part of this application, illustrate embodiments of the disclosure and together with the description serve to explain the principle of the disclosure.

In the drawings:

FIG. 1 illustrates a block diagram of a related art air conditioner, schematically;

FIG. 2 illustrates a block diagram of an air conditioner, to which a method for controlling an air conditioner in accordance with a preferred embodiment of the present invention is applied, schematically;

FIG. 3 illustrates a graph of a refrigerating cycle of the air conditioner in FIG. 2;

FIG. 4 illustrates a flow chart showing the steps of a method for controlling an air conditioner in accordance with a preferred embodiment of the present invention; and

FIG. 5 illustrates a flow chart showing the steps of a method for controlling an air conditioner in accordance with another preferred embodiment of the present invention.

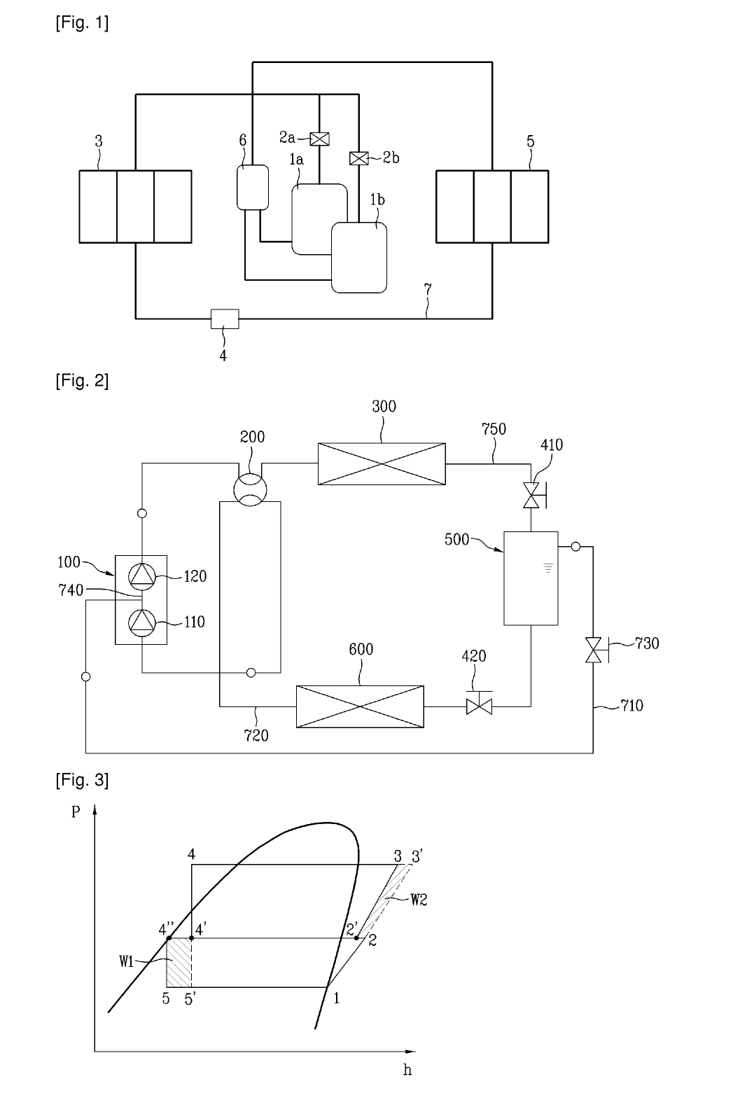

### BEST MODE FOR CARRYING OUT THE INVENTION

Reference will now be made in detail to the specific embodiments of the present invention, examples of which are illustrated in the accompanying drawings. Wherever possible, the same reference numbers will be used throughout the drawings to refer to the same or like parts.

At first, a system of an air conditioner will be described, to which a method for controlling an air conditioner in accordance with a preferred embodiment of the present invention is applied, and in succession, a method for controlling an air conditioner in accordance with a preferred embodiment of the present invention will be described in detail.

FIG. 2 illustrates a block diagram of an air conditioner, to which a method for controlling an air conditioner in accordance with a preferred embodiment of the present invention is applied, schematically.

Referring to FIG. 2, the air conditioning system includes, not only an evaporator 600, a multi-stage compressor 100, a condenser 300, an expansion valve 410 and 420, but also a phase separator 500 for separating gaseous refrigerant and liquidus refrigerant from refrigerant introduced thereto. The air conditioning system also includes a four-way valve 200 for controlling refrigerant being supplied to the condenser 300, the multi-stage compressor 100, and the evaporator 600. The expansion valve has a first valve 410 for controlling a flow rate of, and expanding, the refrigerant being supplied to the phase separator 500, and a second valve 420 for controlling a flow rate of, and expanding, the liquidus refrigerant being supplied to the evaporator 600 from the first valve 410 and the phase separator 500.

The air conditioning system will be described, following a refrigerant flow at the time of room cooling.

The multi-stage compressor 100 includes a first compressor unit 110 to which the refrigerant passed through the evaporator 600 is introduced, and a second compressor unit 120 to which the gaseous refrigerant separated at the phase separator 500 and the refrigerant from the first compressor unit 110 is introduced together. Since the compressor of the present invention is provided with the first, and second compressors 110, and 120, the compressor of the present invention is called as the multi-stage compressor.

Between the phase separator 500 and the compressors 100, there is a refrigerant introducing unit for guiding the refrigerant to the first compressor unit 110 and the second compressor unit 120. The refrigerant introducing unit includes an intermediate refrigerant pipe 740 connected between the first compressor unit 110 and the second compressor unit 120, a first refrigerant pipe 710 connected between the intermediate refrigerant pipe 740 and the phase separator 500, a second refrigerant pipe 720 connected between the first compressor 110 and the phase separator 500 through the evaporator 600, and a control valve 730 for controlling a gaseous refrigerant flow to the second compressor unit 120.

In the meantime, the first valve 410 controls a flow rate, and primarily expands, the refrigerant from the condenser 300, and the second valve 420 controls a flow rate, and secondarily expands, the liquidus refrigerant having phase separated at the phase separator 500. In this case, the refrigerant passed through the condenser 300 is in a supercooled state, and is introduced to the phase separator 500 in a state gaseous refrigerant and liquidus refrigerant is mixed after expanded at the first valve 410.

The phase separator 500 of the present invention is mounted between the first valve 410 and the second valve 420 for separating the liquidus refrigerant from the gaseous refrigerant. The phase separator 500 is connected to a mixed refrigerant pipe 750 for flow of the refrigerant from the condenser 300, to the first refrigerant pipe 710 for flow of the gaseous refrigerant separated at the phase separator 500, and to the second refrigerant pipe 720 for flow of the liquidus refrigerant separated at the phase separator 500.

The liquidus refrigerant separated at the phase separator 500 passes through, and expanded at, the second valve 420, and the liquidus refrigerant passed through the second valve 420 is introduced to, and involved in phase change at the evaporator 600. Then, the gaseous refrigerant passed through the evaporator 600 is introduced to the compressor. i.e., the first compressor 110, through the four-way valve 200.

The gaseous refrigerant separated at the phase separator 500 flows through the first refrigerant pipe 710 and is mixed with the refrigerant from the first compressor unit 110 at the intermediate refrigerant pipe 740. The refrigerant mixed at the intermediate refrigerant pipe 740 is introduced to, and compressed at the second compressor unit 120 again, and discharged to an outside of the compressor 100.

In the meantime, the phase separator 500 of the present invention may be any device as far as the device can separate gaseous refrigerant from the refrigerant from the condenser 300. For an example, the phase separator 500 may be provided with a heat exchanger for making the refrigerant from the condenser 300 to heat exchange with an external air, to obtain the gaseous refrigerant from the refrigerant.

Moreover, mounted on the first refrigerant pipe 710, there is the control valve 730 for controlling the gaseous refrigerant flow. The control valve 730 is controlled by a control unit (not shown) for controlling operation of the air conditioning system. The control unit operates the first compressor unit 110 and the second compressor unit 120, and controls the control valve 730.

Though not shown in the drawing, a capillary tube may be mounted on the first refrigerant pipe 710 for controlling a flow rate of the gaseous refrigerant being introduced to the intermediate refrigerant pipe 740, additionally. That is, by adjusting an inside diameter of the first refrigerant pipe, the flow rate of the gaseous refrigerant being introduced to the intermediate refrigerant pipe 740 can be controlled.

At the end, because the gaseous refrigerant from the phase separator 500 and the refrigerant compressed at the first compressor unit 110 is compressed at the second compressor unit 120 together, compression work applied to the compressor 100 is reduced. As the compression work of the compressor 100 reduces, an operation range of the compressor increases, and as the operation range of the compressor increases, the air conditioning system is operable even in an arctic or tropical region.

Of course, in a state the gaseous refrigerant separated at the phase separator is not supplied to the intermediate refrigerant pipe, i.e., in a state the control valve is closed, only the second compressor unit or both the first and the second compressor unit can be operated. In this instance, the control unit can determine an external load according to an external temperature sensed at the sensor, or a temperature the user set. A method for operating the air conditioning system will be described in detail, later.

FIG. 3 illustrates a graph of a refrigerating cycle of the air conditioner in FIG. 2. A refrigerating cycle applicable to the air conditioning system of the present invention will be described with reference to the drawings.

Referring to FIG. 3, the related art air conditioner system performs a refrigerating cycle having a compression step of 1→3′ a condensing step of an expansion step of 4→5′ and an evaporation step of 5′→1. Opposite to this, the air conditioner system of the present invention performs a refrigerating cycle having a compression step of 1→2→2′→3, a condensing step of 3→4, an expansion step of 4→4′→4″→5, and an evaporation step of 5→1.

At the end, referring to FIG. 3, the air conditioner system of the present invention can output a work as much as W1 additionally, and reduce a compression work as much as W2, thereby improving a performance of the air conditioner system.

In detail, because the refrigerant is supplied to the evaporator 600 in a state (5 in FIG. 3) the temperature of the refrigerant is lower than the related art as the refrigerant passes through the phase separator 500 and the second expansion valve 420, the work of the air conditioner system increases by W1. That is, by making the refrigerant to expand in the steps of 4→4′→4″→5 instead of the step of 4→5′ making the evaporator 600 to pass through a heat exchange step of 5→1, heat exchange efficiency of the evaporator 600 increases, enabling to improve a refrigerating performance of the air conditioning system.

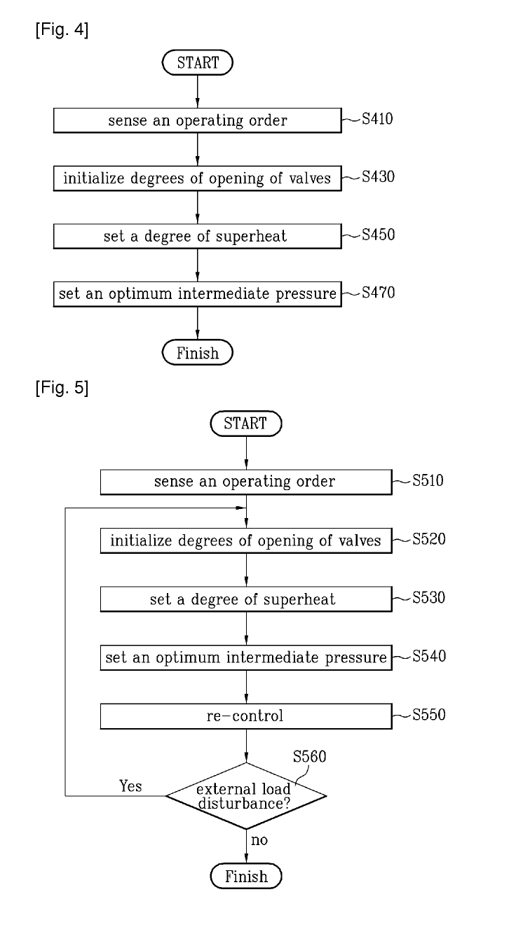

In the meantime, both the gaseous refrigerant separated at the phase separator 500 and the refrigerant passed through the evaporator 600 is introduced to, and mixed at the intermediate refrigerant pipe 740, and as the refrigerant mixed to each other, a temperature of entire refrigerant introduced to the second compressor unit 120 becomes lower than the related art (2′ in FIG. 3). At the end, the refrigerant temperature in the compressor 100 drops from 2 to 2′ in FIG. 4, to reduce external work by W2.

That is, by changing the compression step of 1→3′ in the related art to 1→2→2′→3 in the present invention, the compression work of the compressor 100 required for compressing the refrigerant can be reduced by W2, to enhance a performance and efficiency of the compressor 100 to improve the performance of the air conditioning system.

FIG. 4 illustrates a flow chart showing the steps of a method for controlling an air conditioner in accordance with a preferred embodiment of the present invention.

Referring to FIG. 4, the method for controlling an air conditioner of the present invention includes a step for sensing an operation order of the air conditioner (S410), a step for initializing degrees of opening of valves for stabilizing the air conditioner (S430), a step for setting a degree of superheat (450), and a step for setting a degree of an intermediate pressure. The steps will be described in detail with reference to FIGS. 2 and 4.

Referring to FIGS. 2 and 4, at first, in the method for controlling an air conditioner of the present invention, the step for sensing an operation order of the air conditioner (S410) is performed when the user puts the air conditioner into operation.

In a case the user puts the air conditioner into operation for cooling the room, the control unit (not shown) senses the order, to sense the order for operating the air conditioner (S410).

If the control unit senses the operation order, the control unit initializes degrees of opening of the valves of the air conditioner, to stabilize the air conditioner (S430). The valves initialized in this instance are the first, and second valves 410 and 420 and the control valve 730 as described before.

In detail, in the opening degree initializing step (S430), the first, and second valves 410 and 420 are opened fully and the control valve 730 is closed. As the first, and second valves 410 and 420 are opened fully, in a case the opening degrees of the first and second valves 410 and 420 are controlled, the opening degrees of the first, and the second valves 410 and 420 are controlled with reference to a fully opened state. Moreover, in an initial stage of the valves, the control valve 730 that supplies gaseous refrigerant from the phase separator 500 to the compressor 100 is closed, for preventing liquidus refrigerant from entering into the compressor at the initial stage of operation, to stabilize the air conditioner.

After initializing the opening degrees of the first, and second valves 410 and 420 and the control valve 730, the degree of superheat is controlled so that the refrigerant of the air conditioner of the present invention reaches to a preset degree of superheat (S450).

The degree of superheat is a temperature difference of refrigerant between an outlet of the evaporator 600 and an inlet of the compressor 100. In general, even though the refrigerant passed through the evaporator includes no liquidus refrigerant, there is a case when the refrigerant includes the liquidus refrigerant in a case there is sharp load change. If the liquidus refrigerant is introduced to the compressor, breakage of the compressor or the like is accompanied. Therefore, in order to prevent this, the liquidus refrigerant is eliminated by making the refrigerant to undergo a temperature rise in a process the refrigerant passed through the evaporator is transferred to the compressor. The refrigerant temperature difference between the outlet of the evaporator and the inlet of the compressor is called as the degree of superheat. Though the degree of superheat taken in a case of the air conditioner of the present invention is 2° C., the degree of superheat is not limited to this, but may be varied appropriately taking a type of the air conditioner, a kind of the refrigerant, or cooling capacity, and so on into account.

In the meantime, preferably the step for setting the degree of superheat of the refrigerant described above includes a step for controlling the opening degree of the first valve 410 so that the degree of superheat reaches to a desired degree of superheat, and a step for setting the opening degree of the first valve 410 when the refrigerant reaches to the desired degree of superheat.

There may be two methods in the step of setting the degree of superheat with the opening degree of the first valve 410, i.e., preferably a method in which the degree of superheat is set by making realtime measuring the degree of superheat of the refrigerant while the opening degree of the first valve 410 is varied, and a method in which the degree of superheat of the refrigerant is set by opening the first valve 410 to a predetermined opening degree with reference to a predetermined table.

At first, the method will be discussed, in which the degree of superheat is set by making realtime measuring of the degree of superheat of the refrigerant while the opening degree of the first valve 410 is varied. In the method, realtime measuring of the degree of superheat of the refrigerant is made while the opening degree of the first valve 410 is varied gradually by the control unit until the degree of superheat reaches to the desired degree of superheat when the opening degree of the first valve 410 is set.

That is, since the control valve 730 is in a closed state in the step of initializing a degree of valve opening (S430), the opening degree of the first valve 410 is controlled by the control unit, for controlling a flow rate of the refrigerant introduced to the compressor 100 through the phase separator 500, and the evaporator 600.

In general, if the flow rate of the refrigerant is reduced, evaporation of the refrigerant is completed already before the refrigerant reaches to a second half of the evaporator, to keep heating the gaseous refrigerant to increase the degree of superheat of the refrigerant. opposite to this, if the flow rate of the refrigerant is increased, the degree of superheat is increased.

Therefore, the first valve 410 is in a fully opened state in the step for initializing the opening degree of the valve (S430), in the step for controlling the opening degree of the first valve 410 so that the degree of superheat reaches to a desired degree of superheat, the control unit measures the degree of superheat while the degree of opening of the first valve 410 is reduced, i.e., closing step by step. If the degree of the superheat of the refrigerant reaches to a preset degree of superheat through this process, the control unit sets the opening degree of the first valve 410.

In the meantime, the degree of superheat-of the refrigerant is measured in realtime, and a result of the measuring is transmitted to the control unit wherein a method for measuring the degree of superheat of the refrigerant will be discussed.

As described before, the degree of superheat of the refrigerant is a temperature difference of refrigerant between the outlet of the evaporator 600 and the inlet of the compressor 100. Therefore, in order to measure such a degree of superheat, sensors (not shown) may be mounted to the outlet of the evaporator 600 and the inlet of the compressor 100. The sensors may include a pressure sensor for measuring a pressure of the refrigerant at the outlet of the evaporator 600, and a temperature sensor for measuring a refrigerant temperature at the inlet of the compressor 100. In detail, a saturation temperature of the refrigerant for a pressure of the refrigerant measured at the outlet of the evaporator 600 and a refrigerant temperature measured at the inlet of the compressor 100 are compared, to calculate the degree of superheat.

The second method will be discussed in the step of setting the degree of superheat with the opening degree of the first valve 410, i.e., the method in which the degree of superheat of the refrigerant is set by opening the first valve 410 to a predetermined opening degree with reference to a predetermined table.

In the method, if it is intended to make the refrigerant to reach to a desired degree of superheat, the degree of opening of the first valve 410, i.e., a flow rate of the refrigerant to be supplied to the compressor 100 through the phase separator 500 and the evaporator 600, is determined in advance according to a temperature difference between a room intended to cool and an outside of the room, and stored in the control unit in a form of a table.

In detail, a flow rate of the refrigerant to be supplied to the compressor 100 required for the refrigerant to reach to the desired degree of superheat for types of the air conditioners, and kinds of the refrigerant are determined in advance for each of temperature differences between inside/outside of the room. Therefore, the control unit controls the degree of opening of the first valve 410 according to the flow rate of the refrigerant required for the inside/outside temperature difference, to supply the refrigerant by a determined flow rate for the refrigerant to reach to the desired degree of superheat. Moreover, the degree of opening of the first valve 410 is set as the degree of the opening fixed by the table. As described before, values on the data table are determined according to repetitive experiments assuming various inside/outside temperature differences of the room depending on types of the air conditioners and kinds of the refrigerant. However, the present invention does not define the values in detail.

In the meantime, the step of setting the degree of superheat (S450) further includes a stabilizing step for stabilizing the air conditioning system after setting the degree of opening of the first valve 410 as the degree of superheat reaches to the desired degree of superheat.

In this instance, in the stabilizing step which is a step for stabilizing a state the refrigerant reaches to the desired degree of superheat in the step for controlling the opening degree of the first valve 410 so that the degree of superheat reaches to a desired degree of superheat described before, lapse of a predetermined time period of, for an example, 30 seconds, is waited for the stabilization. In the meantime, the time period required for this step may be varied with types of the air conditioners and the kinds of refrigerant, appropriately.

After making the degree of superheat of the refrigerant to reach to the desired degree of superheat by controlling the degree of opening of the first valve 410, a pressure of the refrigerant is made to reach to a preset optimum intermediate pressure (S470).

The intermediate pressure is a difference of gaseous refrigerant pressure at opposite ends of a line through which the phase separator 500 discharges the gaseous refrigerant to supply the gaseous refrigerant to the compressor 100, i.e., the first refrigerant pipe 710 connected between the intermediate refrigerant pipe 740 and the phase separator 500. At the end, in the present invention, the intermediate pressure is defined as a pressure difference taken place during the gaseous refrigerant separated from the liquidus refrigerant at the phase separator 500 is introduced to the intermediate refrigerant pipe 740 of the compressor 100 through the first refrigerant pipe 710.

In the meantime, the optimum intermediate pressure is an intermediate pressure that can maximize efficiency of the air conditioner, i.e., an intermediate pressure that can maximize areas of W1 which is a work provided to an outside and W2 which shows a reduced compression work in FIG. 3. That is, by making the intermediate pressure of the refrigerant to reach to the optimum intermediate pressure, an amount of work provided to an outside can be increased and, opposite to this, the work required for the compressor can be reduced. In the air conditioner having a multi-stage compressor of the embodiment, the optimum intermediate pressure is 5 psi. The optimum intermediate pressure can vary with types of the air conditioner, and the foregoing value is merely an example.

There are a variety of methods for obtaining the intermediate pressure, for an example, the intermediate pressure can be obtained by calculation using pressures of the condenser 300 and the evaporator 600, or by measuring pressures at opposite ends of a line through which the phase separator 500 discharges the gaseous refrigerant to supply the gaseous refrigerant to the compressor 100, i.e., the first refrigerant pipe 710 connected between the intermediate refrigerant pipe 740 and the phase separator 500.

In this instance, the method for calculating the intermediate pressure by using the pressures of the condenser 300 (Pd) and the evaporator 600 (Ps) may be expressed as the following equation (1).

Intermediate pressure=\sqrt{P_{d}×P_{S}} (1)

In the embodiment, sensors are mounted to the inlet and outlet of the compressor 100 to measure a pressure of the evaporator 600 and a pressure of the condenser 300, and calculate the intermediate pressure with the equation (1).

Accordingly, as described later, by controlling the flow rate of the gaseous refrigerant being supplied to the intermediate pressure pipe 740 from the phase separator 500 with the degree of opening of the control valve 730, the pressures of the compressor 600 and the condenser 300 are controlled, so that the intermediate pressure calculated with the equation (1) can be the optimum intermediate pressure.

In the meantime, the method for obtaining the intermediate pressure by measuring the pressures at the opposite ends of the first refrigerant pipe 710 directly will be discussed. In the method, sensors are mounted to the opposite ends of the first refrigerant pipe 710, in detail, one end where the first refrigerant pipe 710 is connected to the phase separator 500, and the other end where the first refrigerant pipe 710 is connected to the intermediate refrigerant pipe 740, to measure pressures at the opposite ends of the first refrigerant pipe 710, directly. Therefore, as described later, by controlling the flow rate of the gaseous refrigerant being supplied to the intermediate pressure pipe 740 from the phase separator 500 with the degree of opening of the control valve 730, the pressure difference between the opposite ends of the first refrigerant pipe 710 is controlled to be the optimum intermediate pressure.

Moreover, the step for making a pressure of the refrigerant to reach to a preset optimum intermediate pressure (S470) described before may be performed by two methods. Preferably, in a method of the present invention, the intermediate pressure of the refrigerant is measured in real time while varying the degree of opening of the control valve 730 to set the optimum intermediate pressure, and in another method, the control valve 730 is opened to a predetermined degree of opening according to a predetermined data table to set the optimum intermediate pressure.

At first, the method for setting the optimum intermediate pressure by measuring the intermediate pressure of the refrigerant in real time while varying the degree of opening of the control valve 730 will be discussed. In the method, while the degree of opening of the control valve 730 is varied slowly with the control unit, the intermediate pressure of the refrigerant is measured in real time, to reach to the desired optimum intermediate pressure.

That is, since the control valve 730 is closed in the step for initializing the degree of opening of the valve (S430), the degree of opening of the control valve 730 is controlled with the control unit, i.e., the control valve 730 is opened slowly, so that the flow rate of the gaseous refrigerant being supplied from the phase separator 500 to the compressor 100 is increased. As the flow rate of the gaseous refrigerant being supplied from the phase separator 500 to the compressor 100 is increased, pressures of refrigerant at the condenser 300 and the evaporator 600 change following change of the pressures at the opposite ends of the first refrigerant pipe 710.

Accordingly, as described before, the control unit calculates the intermediate pressure by using the pressures at the opposite ends of the first refrigerant pipe 710 or the pressures at the condenser 300 and the evaporator 600, and changes the degree of opening of the control valve 710 so that the calculated intermediate pressure is the same with the optimum intermediate pressure. As the methods for calculating the intermediate pressure by using the pressure difference between the opposite ends of the first refrigerant pipe 710 or the pressures of the refrigerant at the condenser 300 and the evaporator 600 are described in detail before, detailed description of which will be omitted.

The second method in the step for setting the intermediate pressure of the refrigerant as the optimum intermediate pressure with the degree of opening of the control valve 730, i.e., the method for opening the control valve 730 to a predetermined degree of opening according to a predetermined data table to set the optimum intermediate pressure, will be described.

In the method, in a case when it is intended to make the refrigerant to reach to the desired intermediate pressure, the degree of opening of the control valve 730, i.e., the flow rate of the gaseous refrigerant being supplied to the compressor 100 from the phase separator 500, is determined according to a temperature difference between inside/outside of the room to be cooled in advance, and stored in the control unit in a form of a table.

In detail, a flow rate of the gaseous refrigerant to be supplied to the compressor 100 required for the gaseous refrigerant to reach to the optimum intermediate pressure for types of the air conditioners, and kinds of the refrigerant are determined in advance for each of temperature differences between inside/outside of the room. Therefore, the control unit controls the degree of opening of the control valve 730 according to the flow rate of the gaseous refrigerant required for the inside/outside temperature difference, to supply the gaseous refrigerant by a determined flow rate for the gaseous refrigerant to reach to the optimum intermediate pressure. As described before, values on the data table are determined according to repetitive experiments assuming various inside/outside temperature differences of the room depending on types of the air conditioners and kinds of the refrigerant. However, the present invention does not define the values in detail.

In the meantime, FIG. 5 illustrates a flow chart showing the steps of a method for controlling an air conditioner in accordance with another preferred embodiment of the present invention.

In comparison to the foregoing embodiment, the embodiment in FIG. 5 is different in that a step (S550) for re-controlling and a step (S560) for sensing external turbulence are further included thereto.

Referring to FIG. 5, even if a step (S540) for setting the optimum intermediate pressure with the control valve 730 is performed, even if the gaseous refrigerant is supplied to the compressor 100 by the control valve 730, the degree of superheat set in the step for setting the degree of superheat may not be the same with the predetermined degree of superheat. Therefore, preferably, the embodiment further includes the step (S550) for re-controlling the degree of superheat and the intermediate pressure after setting the optimum intermediate pressure.

In detail, in the re-controlling step (S550), the degree of opening of the second valve 420 is controlled, so that the degree of superheat is the same with the predetermined degree of superheat, while the intermediate pressure is the same with the optimum intermediate pressure.

In this instance, since the degree of opening of the second valve 420 is in a fully opened state in the step (S520) for initializing the degree of opening, in the re-controlling step (S550), the second valve 420 is closed slowly, to control the flow rate of the liquidus refrigerant to the evaporator 600 from the phase separator 500. According to this, the flow rate of the refrigerant supplied to the compressor 100 through the evaporator 600 is controlled, to control the degree of superheat as described before.

Moreover, since the refrigerant pressure at the evaporator 500 can be controlled by controlling the flow rate of the refrigerant supplied to the evaporator 500 with the second valve 420, it is possible to control the intermediate pressure by using this. Because detailed methods for setting the degree of superheat and the intermediate pressure are described in detail in the embodiment shown in FIG. 4, detailed description will be omitted. Accordingly, in the re-controlling step (S550), the degree of opening of the second valve 420 is controlled, to match the degree of superheat of the refrigerant and the intermediate pressure to predetermined values, respectively.

In the meantime, even if the degree of superheat and the intermediate pressure are controlled to match to the predetermined values respectively according to the re-controlling step (S550), in a case an external load disturbance takes place to the air conditioner, the degree of superheat and the intermediate pressure can not be matched to the predetermined values, respectively.

That is, when the external load disturbance, such as opening of a door to let outdoor warm air to enter into the room, or many people enter into the room, takes place, the room air temperature rises. Therefore, because the degree of superheat and the intermediate pressure of the refrigerant of the air conditioner do not match to the predetermined values, but become different, re-controlling of the degree of superheat and the intermediate pressure is required.

In the case the external load disturbance takes place thus, the control unit senses it and repeats the step (S520) for initializing the degree of opening of the valve, the step (S530) for setting the degree of superheat, the step (S540) for setting the optimum intermediate pressure, and the re-controlling step (S550) again, so that the degree of superheat and the intermediate pressure are matched to the predetermined values, respectively (S560). According to this, the degree of superheat and the intermediate pressure are made to match to the predetermined values respectively even if the external load disturbance takes place, to permit the air conditioner to be operated in an optimum state.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

### INDUSTRIAL APPLICABILITY

As has been described, the method for controlling an air conditioner of the present invention has the following advantages.

The closure of the control valve at an initial stage of operation of the air conditioner, which supplies refrigerant from the phase separator to the compressor permits to prevent the liquidus refrigerant from entering into the compressor.

The controlling of the degree of superheat and the intermediate pressure of the refrigerant to match to predetermined values at an initial stage of operation permits to improve efficiency of the air conditioner, substantially.

1. A method for controlling an air conditioner having a phase separator, an expansion valve, a control valve, an evaporator, a multistage compressor, and a condenser, comprising the steps of:
sensing an order to operate the air conditioner;
stabilizing the air conditioner;
setting a degree of superheat of refrigerant in the air conditioner; and
setting an optimum intermediate pressure of the refrigerant of the air conditioner.

2. The method as claimed in claim 1, wherein the expansion valve includes a first valve for expanding the refrigerant being supplied to the phase separator from the condenser, and a second valve for expanding liquidus refrigerant being supplied from the phase separator to the evaporator, and the control valve guides gaseous refrigerant to the multistage compressor from the phase separator, wherein the step of stabilizing the air conditioner includes the step of initializing degrees of opening of the first, and second valve, and the control valve.

3. The method as claimed in claim 2, wherein the step of initializing degrees of opening includes the step of full opening of the first, and second valves, and full closing the control valve.

4. The method as claimed in claim 2, wherein the step for setting a degree of superheat of refrigerant includes the step of controlling the degree of superheat such that the refrigerant in the air conditioner reaches to a predetermined degree of superheat.

5. The method as claimed in claim 4, wherein the step for setting a degree of superheat of refrigerant includes the steps of;
controlling the degree of opening of the first valve until the degree of superheat of the refrigerant reaches to the predetermined degree of superheat, and
setting the degree of opening of the first valve in a case the refrigerant reaches to the predetermined degree of superheat.

6. The method as claimed in claim 5, wherein the step for controlling the degree of opening of the first valve includes the step of varying the degree of opening of the first valve until the degree of superheat of the refrigerant reaches to the predetermined degree of superheat of the refrigerant by measuring the degree of superheat of the refrigerant.

7. The method as claimed in claim 6, wherein the degree of superheat is measured with sensors mounted to an outlet of the evaporator and an inlet of the compressor, respectively.

8. The method as claimed in claim 7, wherein the sensors are temperature sensors.

9. The method as claimed in claim 7, wherein the sensors are pressure sensors.

10. The method as claimed in claim 5, wherein the step of controlling the degree of opening of the first valve includes the step of opening the first valve to a predetermined degree of opening with reference to a table predetermined according to temperature differences between inside/outside of a room so that the refrigerant reaches to the predetermined degree of superheat.

11. The method as claimed in claim 5, wherein the step for setting the degree of opening of the first valve further includes the step of stabilizing in which lapse of a predetermined time period is waited in a state the degree of opening of the first valve is set.

12. The method as claimed in claim 2, wherein the step of setting an optimum intermediate pressure of the refrigerant of the air conditioner includes the step of controlling the intermediate pressure so that the refrigerant of the air conditioner reaches to a predetermined optimum intermediate pressure.

13. The method as claimed in claim 12, wherein the step of setting an optimum intermediate pressure of the refrigerant of the air conditioner includes the step of controlling the degree of opening of the control valve so that the refrigerant reaches to the predetermined optimum intermediate pressure.

14. The method as claimed in claim 13, wherein the step of setting an optimum intermediate pressure of the refrigerant of the air conditioner includes the step of varying the degree of opening of the control valve until the refrigerant reaches to the predetermined optimum intermediate pressure by measuring the intermediate pressure of the refrigerant.

15. The method as claimed in claim 14, wherein the intermediate pressure is measured with sensors mounted to opposite ends of a line through which gaseous refrigerant is discharged from the phase separator, respectively.

16. The method as claimed in claim 14, wherein the intermediate pressure is measured with sensors mounted to an inlet and an outlet of the compressor, respectively.

17. The method as claimed in claim 15 or 16, wherein the sensors are temperature sensors.

18. The method as claimed in claim 15 or 16, wherein the sensors are pressure sensors.

19. The method as claimed in claim 13, wherein the step of setting an optimum intermediate pressure of the refrigerant of the air conditioner includes the step of opening the control valve to a predetermined degree of opening with reference to a data table predetermined according to temperature differences between inside/outside of a room, so that the refrigerant reaches to the optimum intermediate pressure.

20. The method as claimed in claim 13, further comprising a re-controlling step for controlling the degree of opening of the second valve until the degree of superheat and the intermediate pressure of the refrigerant reach to predetermined values again in a case the degree of the superheat fails to be the same with the predetermined degree of superheat of the refrigerant by the control of the control valve.

21. The method as claimed in claim 20, further comprising the step of repeating the step of setting a degree of superheat of refrigerant in the air conditioner, the step of setting an optimum intermediate pressure of the refrigerant of the air conditioner, and the re-controlling step if an external load disturbance takes place after the re-controlling step.

22. A method for controlling an air conditioner having a phase separator, an expansion valve, a control valve, an evaporator, a multistage compressor, and a condenser, wherein the expansion valve includes a first valve for expanding refrigerant being supplied from the condenser to the phase separator, and a second valve for expanding liquidus refrigerant being supplied from the phase separator to the evaporator, and the control valve guides gaseous refrigerant from the phase separator to the multistage compressor, comprising the steps of:
sensing an order to operate the air conditioner;
initializing degrees of opening of the first, second valves, and the control valve;
controlling a degree of superheat of refrigerant in the air conditioner so that the refrigerant reaches to a predetermined degree of superheat;
controlling an intermediate pressure of the refrigerant of the air conditioner so that the refrigerant reaches to a predetermined optimum intermediate pressure;
re-controlling the degree of superheat and the intermediate pressure of the refrigerant to the predetermined values again; and
repeating the step of initializing degrees of opening of the first, second valves, and the control valve, controlling a degree of superheat of refrigerant in the air conditioner, controlling an intermediate pressure of the refrigerant of the air conditioner, and re-controlling the degree of superheat and the intermediate pressure of the refrigerant again if an external load disturbance takes place after the re-controlling step.
